(19) United States
(12) Patent Application Publication
(10) Pub. No.: US 2018/0089182 A1
(43) Pub. Date: Mar. 29, 2018

(54) HYBRID CROSS-PLATFORM SEARCH

(71) Applicant: MICROSOFT TECHNOLOGY LICENSING, LLC, Redmond, WA (US)

(72) Inventors: Michael GLADISHEV, Tel Aviv (IL); Nir NAHUM, Rishon Le Zion (IL); Nir GAFNI, Rishon Le Zion (IL); Mark WAITSER, Ramat Gan (IL); Michal Ben YAACOV, Ganei Tikva (IL); Yaron LANDAU, Ra'anana (IL); Ziv CIZER, Tel Aviv (IL); Alon KOLLMANN, Ra'anana (IL); Shani NITZAN, Ramat Hasharon (IL); Or COHEN, Maabarot (IL)

(21) Appl. No.: 15/637,548

(22) Filed: Jun. 29, 2017

Related U.S. Application Data
(60) Provisional application No. 62/399,440, filed on Sep. 25, 2016.

(51) Int. Cl. G06F 17/30

(52) U.S. Cl. CPC G06F 17/301; G06F 17/30115; G06F 17/30997; G06F 17/30112; G06F 17/30268; G06F 17/30253

(57) ABSTRACT

Embodiments allow for searching across multiple devices for user content. A user enters search criteria in a user interface client, which forwards the search criteria to a central search server. The search server forwards the search criteria to search agents on a plurality of other devices associated with the user. The search agents use local search functionality to identify any content that meets the search criteria. The search agents send result metadata to the user interface client via the search server. The user interface client combines result metadata from multiple devices for presentation to the user. After the user selects desired content, the selected content is retrieved from a hosting remote device via the search server.

### CROSS-REFERENCE TO RELATED APPLICATIONS

This application claims the benefit of the filing date of U.S. Provisional Patent Application No. 62/399,440, which was filed Sep. 25, 2016, the disclosure of which is hereby incorporated by reference herein in its entirety.

### BACKGROUND

It is typical for most people to have three or more electronic devices for personal use, such as smartphones, tablets, personal computers, laptops, game consoles, etc. Often, people have more than one of some types of devices because they use both personal and work devices (e.g., two smartphones and/or two computers). The average person uses each device in different places and situations. For example, a person may use their game console at home, their smartphone all day long, and their laptop at work. As a result, a user's content, such as pictures, documents, videos, messages, etc., is spread across different devices based upon where the content was created or when the user received the content.

In many cases people need content that is stored on a device other than the one they are currently using. In most cases users know where desired data is located, but they need it on different device. In the worse cases, the users do not even know on which device desired content is stored.

Different device platforms have different capabilities and functionalities. Each device has its own local storage that allows access to locally stored data only through that device. Most devices have a storage capacity limitation. For example, a smartphone typically has a small data storage capability relative to a personal computer and cannot store large amounts of new content without first transferring old content to a different storage device. As a result, the old content will become unreachable from the original device.

Content is often relevant to multiple users and should be consumed by more than one person. Therefore, the content needs to be shared not only among one user's devices, but also shared with other people. For example, pictures may need to be shared with family members and work documents may need to be shared with coworkers.

In existing systems, users may share documents across different devices by sending content by email, messaging, or other communication services. However, this solution only applies when users know exactly where the content is stored and when the users have access to the content. Sharing content from one device to another results in duplication of the content on both devices and may further store the content on a communications platform server. Moreover, the size of content that can be shared may be limited according to the storage limitations of the platforms being used.

Some existing services, such as the OneDrive® service from Microsoft Corporation or the Dropbox® service from Dropbox, Inc., provide the capability to synchronize content across multiple devices. These services provide access to all content but have significant disadvantages. All the content synchronized in this way must be uploaded to a cloud storage from the originating device and then stored to all associated devices. For many users, most of the content that is synchronized will never be used by a device other than the originating device. As a result, a large amount of content is duplicated across several devices on limited data storage space for no good reason. Additionally, the synchronization process for a new device is complicated because it requires all the data to be duplicated the first time the device is linked to the system. This can take a very long time and requires large bandwidth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments allow for searching across multiple devices for user content. A user enters search criteria in a user interface client, which forwards the search criteria to a central search server. The search server forwards the search criteria to search agents on a plurality of other devices associated with the user. The search agents use local search functionality to identify any content that meets the search criteria. The search agents send result metadata to the user interface client via the search server. The user interface client combines result metadata from multiple devices for presentation to the user. After the user selects desired content, the selected content is retrieved from a hosting remote device via the search server.

A hybrid cross-platform search system provides data accessibility across all of a user's physical devices and networked and virtual services while taking advantage of each device or service's storage and processing capabilities. The hybrid cross-platform search system leverages the separate and independent physical devices and networked and virtual services into one whole mechanism as an ad hoc private cloud.

A method for providing a hybrid cross-platform search comprises: receiving search criteria at a user interface client on a user device; sending the search criteria to a search server; forwarding the search criteria from the search server to search agents on one or more remote devices; searching content on the remote devices by the search agents using the search criteria; sending result metadata from the search agent on each remote device to the search server; forwarding the result metadata to the user interface client; and combining the result metadata for presentation to the user.

The method for providing a hybrid cross-platform search may further comprise: receiving a content selection from the user; sending the content selection to the search server; forwarding the content selection to the search agent on a remote device associated with the content selection; sending selected content from the search agent on the remote device to the search server; and forwarding the selected content to the user interface client on the user device.

The method for providing a hybrid cross-platform search may further comprise: providing the search criteria to a local search agent on the user device; searching content on the user device by the local search agent using the search criteria; sending result metadata from the local search agent to the user interface client; and combining the result metadata from the local search agent and from the remote devices for presentation to the user.

A system for providing a hybrid cross-platform search comprises: one or more physical devices each having content storage; one or more network or virtual applications providing content storage; search agents on each of the physical devices and associated with the network or virtual applications; at least one client user interface allowing a user to initiate a content search across each of the physical devices and the network or virtual applications; and a search server coupled to the physical devices and the network or virtual applications, the search server managing distribution of search criteria from the client user interface to the search agents and managing return of result metadata to the client user interface.

### DRAWING

To further clarify the above and other advantages and features of embodiments of the present invention, a more particular description of embodiments of the present invention will be rendered by reference to the appended drawing. It is appreciated that these drawing depicts only typical embodiments of the invention and are therefore not to be considered limiting of its scope. The invention will be described and explained with additional specificity and detail through the use of the accompanying drawings in which:

FIG. 1 is a block diagram of a system providing a hybrid cross-platform search according to one embodiment.

FIG. 2 is a block diagram of a system providing a hybrid cross-platform search according to an alternative embodiment.

FIG. 3 is a flowchart of a computer-implemented method for cross-platform searching according to one embodiment.

FIG. 4 is a flowchart of a computer-implemented method for retrieving content in a cross-platform searching system according to one embodiment.

### DETAILED DESCRIPTION

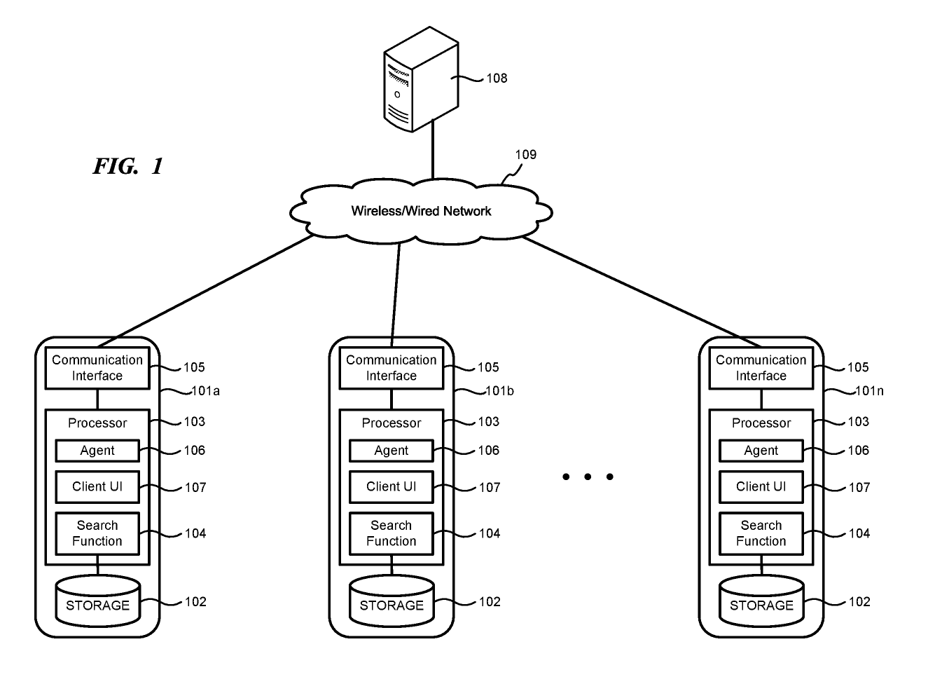

FIG. 1 is a block diagram of a system providing a hybrid cross-platform search according to one embodiment. A user has content stored on multiple devices 101a-n. The content may include, for example, images, videos, messages, music, documents, spreadsheets, presentations, databases, and the like. The devices 101a-n may be, for example, smartphones, tablets, laptop computers, personal computers, terminals, servers, or other devices capable of storing data. Content may be stored on each device 101a-n in a storage 102. Some devices 101a-n may have more than one storage 102. Depending upon the device type, storage 102 may take the form of volatile or non-volatile memory, such as dynamic random-access memory (DRAM), static random-access memory (SRAM), flash memory, solid-state storage, magnetic tape, hard disk drive, optical disk drive, or any other structure configured to store data temporarily or permanently.

Each device 101a-n has a processor 103 or other computing device that controls device operations and/or executes software or firmware applications. In one embodiment, processors 103 execute a search functionality 104 that provides that capability to find and identify content in storage 102. The search functionality may be one or more of, for example, an indexing function, a memory control function, a file allocation function, or memory management function. In other embodiments, search functionality 104 may be provided by a memory controller or other that component that handles memory and caching operations associated with processor 103.

Devices 101a-n comprise a communication interface 105 that allows the devices to communicate with each other and/or other systems. Communication interface 105 may be a transceiver that provides wireless communications using, for example, long-term evolution (LTE), Bluetooth, WiFi (IEEE 802.11), or any other wide area, local area, or personal area network protocols. Alternatively, communication interface 105 may be a network interface card (NIC) or network adapter that provides communication over wired networks.

Devices 101a-n may belong to or are associated with a single user who has different content stored across each device and would like to access all content from whichever device is currently being used. In one embodiment, an agent 106 on each device 101a-n provides access to the device and allows for cross-platform searching. A client user interface (UI) 107 is loaded on at least one device 101n and allows the user to enter search criteria, to review cross-platform search results, and to select relevant content to be accessed. A server 108 may mediate between the agents 106 and client UI 107. In alternative embodiment, agents 106 and client UI 107 on devices 101a-n may communicate directly in a peer-to-peer manner or through a central wireless or wired network 109.

Agent 106 and client UI 107 may be software applications. The user installs these applications on each device 101a-n to allow them to connect to each other. Agent 106 and client UI 107 may be stand-alone applications that are loaded on devices 101. Alternatively, agent 106 and client UI 107 functionality may be integrated into existing applications, such as the built-in indexer in the operating system or in agents for other document-sharing applications (e.g., a OneDrive® agent), or a voice activated assistant (e.g., the Cortana™ assistant from Microsoft Corporation. The client UI 107 only needs to be installed on devices from which a user wants to access other devices and, therefore, is not required on devices 101 that act as storage only.

A primary user may assign permissions to others by defining users that can access the content on device. Additionally, users may assign or restrict permission to access portions of storage 102. A user may declare “black spots” on a device 101, which would prevent other devices from accessing the defined sections of storage 102 or certain stored content. Such a designation would prevent identification of any content within the black-spot region. Transfer of black-spot content to other devices would also be blocked. Alternatively, users may define “white spots,” which would permit access from other devices to only selected sections of storage 102 or to certain stored content.

Each agent 106 contacts server 108 with a long poll request or with a timer for short poll requests. The agent 106 then waits for a response to define the required action. By working with polling requests, agent 106 will have only outgoing traffic and not incoming traffic, which makes the data searching more secure. The type of polling may be determined by the device type, such as battery life impact from keeping polls open.

On the client UI 107 side, credentials are required to authenticate the user before the user can enter search criteria into the client UI 107. Authentication may be implemented with existing credentials used by the device 101 or with credentials specifically used with the hybrid cross-platform search service. After passing a login page, the users may enter search criteria for desired content by entering any appropriate sets of parameters. The search parameters may include any information that each of the different devices 101a-n can search on, such as, for example, content name, created, date modified, file path, file type, file size, creator, editors, internal content (i.e., text search in file), etc. Additionally, search strings with wild cards, such as “*.jpg”, can be used. The search criteria, user identification, and client identification are passed from the client UI 107 to server 108 and then to all the agents 106 as a response to the agent's polling requests.

Each agent 106 will search locally using the search criteria while taking in consideration the authorization of the user and any predefined limitations applied on the device, such as black spots and white spots. The agent 106 may use the local or native search functionality 104 to complete the search. As each agent 106 obtains its search results, the agents send result metadata, including an agent identification, to server 108. The server 108 forwards the result metadata to the relevant client UI 107 that initiated the search request.

The search-initiating client UI 107 combines the result metadata from all the agents 106 and presents the results to the user while making it transparent to the user that the content is not physically located on the requesting device. The user may then select the desired content. When the user selects the desired content, the client UI 107 makes a content request to server 108 with the agent identification, client identification, user identification, and the exact content information (for example, a file path) associated with where the desired content is located. The server 108 responds to the polling request of the relevant agent 106 with the content request. The agent 106 will send the desired content to server 108, which forwards the desired content to the relevant client UI 107. This can be accomplished, for example, by passing the entire content file or by streaming the content to the requesting device.

In an alternative embodiment, the server 108 can be avoided and the devices 101a-n may support peer-to-peer communication between the client UI 107 and the agents 106.

The hybrid cross-platform search system described herein allows for parallel search according to the built-in indexing mechanism 104 of each device 101a-n. Each storage 102 on each device 101a-n uses its own indexing mechanism 104, which allows the device to find content efficiently according to its design. By paralleling the search and passing the search criteria to each device, the processing logic is distributed among the devices. The system allows the processing unit 103 of each device 101a-m to perform an optimum search according to each device's design. Accordingly, agent 106 and client UI 107 do not have to understand the indexing or operation of storage 102 on each device 101.

Content is available on demand using the hybrid cross-platform search system. The content of each device 101a-n stays on that device until the user needs it on another device. There is no need for data transfer between the devices 101a-n or to the server 108 until a search request has been initiated. This allows the system to maintain a low bandwidth usage and prevents data duplication. By reducing or preventing duplication, the user keeps only the latest version of the data content.

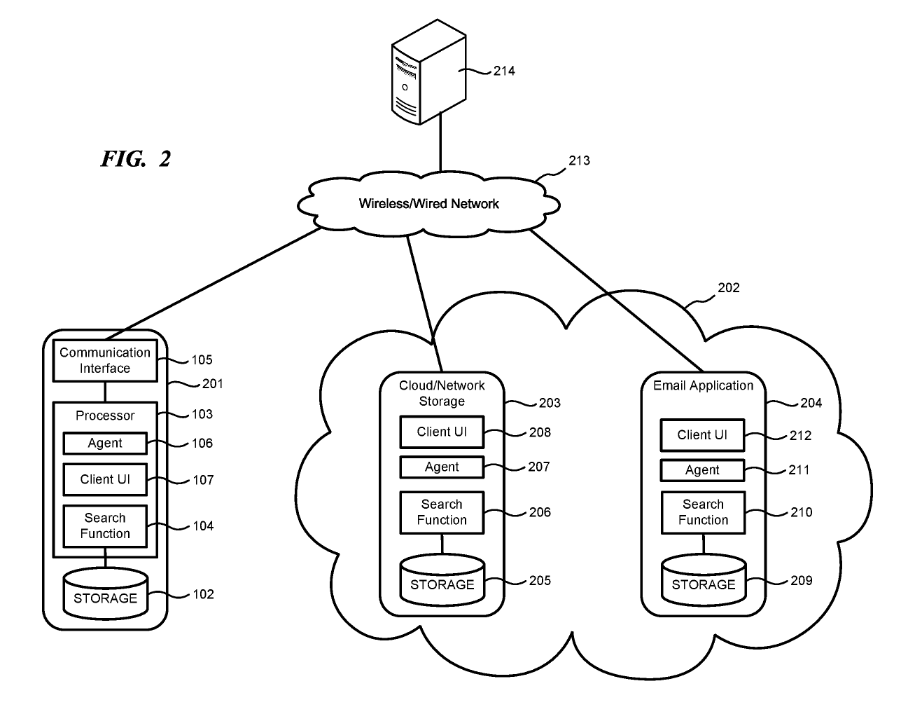

FIG. 2 is a block diagram of a system providing a hybrid cross-platform search according to an alternative embodiment in which content is associated with or stored with networked or virtual applications. A user may have some content stored on one or more personal device 201, such as a smartphone, tablet, or computer, and other content stored on one or more networks 202. For example, network 202 may be a public, private, or enterprise network or a cloud service. Network 202 may host a cloud or network storage application 203 and/or an electronic mail application 204 as well as other hosted or virtual applications and services.

Each of these network or cloud applications or services may store content associated with the user. For example, cloud or network storage application 203 may store user content in network storage 205. The cloud or network storage application 203 has its own search functionality 206. An agent 207 may be associated with cloud or network storage application 203 to allow the user to locate content in storage 205. Additionally, a client user interface 208 may be associated with application 203 to allow the user to initiate content searches from the cloud or network storage application 203.

Email application 204 may store user content in storage 209, such as saved messages, message attachments, contact lists, configuration data, etc. The email application 204 has its own search functionality 210. An agent 211 may be associated with email application 204 to allow the user to locate content in storage 209. Additionally, a client user interface 212 may be associated with application 204 to allow the user to initiate content searches from the email application 204. For example, a user may want to attach content to a new message using email application 204 and may use client UI 212 to search across all of the user's content to select an attachment. Using this system, a file stored on storage 102 may be attached to a message generated on email application 204 without requiring the file to first be transferred to email storage 209.

The embodiment illustrated in FIG. 2 allows the user to search for content across all of the user's physical devices and any networked, cloud, or virtual applications or services locate desired content. Agent applications 106, 207, and 211 and client UI 107, 208, and 212 function as described above with respect to FIG. 1. Search criteria and result metadata may be exchanged through one or more networks 213 and may be mediated by a central search server 214.

Bandwidth usage is reduced in the hybrid cross-platform search system because only metadata is shared at first. Typically, there will be more than one initial result when searching because there is content with similar attributes and/or the search criteria are not focused enough. To allow the user to determine which exact content is desired, and while avoiding transfer of all content that fits the search criteria, only the search-result metadata is transferred to the user's device at first. The search-result metadata includes the name of the device where the content is located, the original file path, file type, creation date, size, and any other relevant information regarding the content other than the content itself. Using this information, the user can select the desired content to be transferred from the source device to the requesting device with minimal bandwidth usage.

The client user interface combines the search results received from all of the devices into one list. This allows the user to identify which device is storing the listed content as well as viewing additional content metadata. By selecting the relevant content, the user will be able to transfer that content from the original device to the device that initiated the search request. Alternatively, the displayed results may not identify a source device so that the fact that certain content is not physically located on the user's device is transparent to the user.

When users share their data with other users, they will be able to define their permissions. The permissions may define a time limitation so that a specified user will be able to access content only during the specified period.

The users may declare black spots in their devices, meaning parts of the data storage would not be accessible and the content in these areas will not transfer to other devices. Additionally, or alternatively, the user may define white spots and only those sections of the storage will be accessible from other devices.

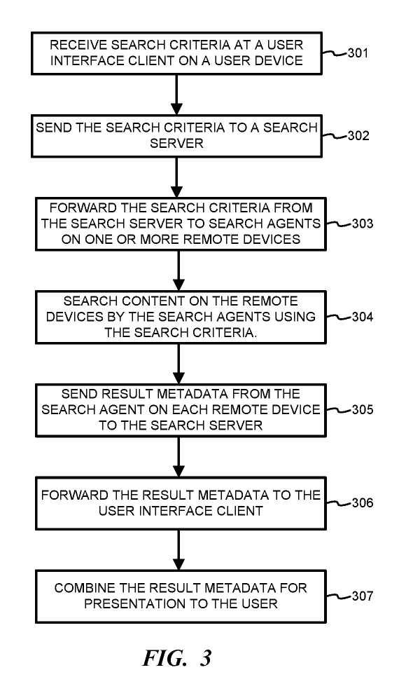

FIG. 3 is a flowchart of a computer-implemented method for cross-platform searching according to one embodiment. In step 301, search criteria are received at a user interface client on a user device. In step 302, the search criteria are sent to a search server. In step 303, the search criteria are forwarded from the search server to search agents on one or more remote devices. In step 304, content is searched on the remote devices by the search agents using the search criteria.

In step 305, result metadata is sent from the search agent on each remote device to the search server. In step 306, the result metadata is forwarded to the user interface client. In step 307, the result metadata is combined for presentation to the user.

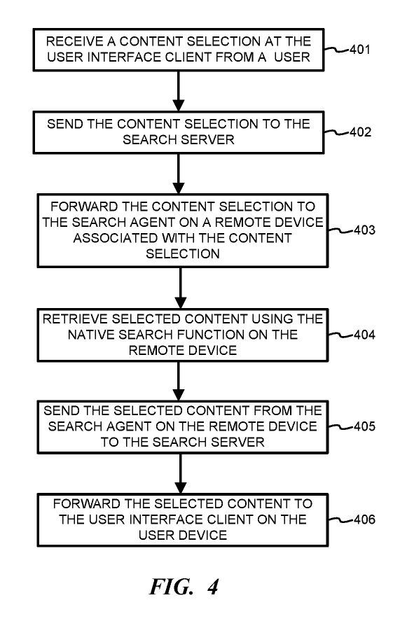

FIG. 4 is a flowchart of a computer-implemented method for retrieving content in a cross-platform searching system according to one embodiment. In step 401, a content selection is received at the user interface client from the user. In step 402, the content selection is sent to the search server. In step 403, the content selection is forwarded by the search server to the search agent on a remote device associated with the content selection. In step 404, the selected content is retrieved from storage using the native search function on the remote device.

In step 405, the selected content is sent from the search agent on the remote device to the search server. In step 406, the selected content is forwarded to the user interface client on the user device where the content can be accessed by the user.

An example computer-implemented method comprises: receiving search criteria at a user interface client on a user device; sending the search criteria to a search server; receiving result metadata at the user interface client from the search server; and combining the result metadata for presentation to the user.

The computer-implemented method may further comprise: forwarding the search criteria from the search server to search agents on one or more remote devices; receiving the result metadata from the search agent on each remote device at the search server; and forwarding the result metadata to the user interface client.

The computer-implemented method may further comprise: searching content on the remote devices by the search agents using the search criteria; and sending the result metadata from the search agent on each remote device to the search server.

The computer-implemented method may further comprise: receiving a content selection from the user; sending the content selection to the search server; forwarding the content selection to the search agent on a remote device associated with the content selection; sending selected content from the search agent on the remote device to the search server; and forwarding the selected content to the user interface client on the user device.

The computer-implemented method may further comprise: providing the search criteria to a local search agent on the user device; searching content on the user device by the local search agent using the search criteria; sending result metadata from the local search agent to the user interface client; and combining the result metadata from the local search agent and from the remote devices for presentation to the user.

The computer-implemented method may further comprise: sending the search criteria from the search server to search agents on one or more remote devices in response to poll requests from the search agents.

The computer-implemented method may further comprise: searching content in storage regions designated on a white list on the remote devices.

The computer-implemented method may further comprise: searching content in storage regions not designated on a black list on the remote devices.

The metadata in the computer-implemented method may comprise one or more of a name of a device where content is located, an original file path, a file type, a file creation date, a file size, and/or relevant information regarding the content other than the content itself.

In an example embodiment, a system comprises two or more physical devices each having content storage; search agents on each of the physical devices; at least one client user interface allowing a user to initiate a content search across each of the physical devices; and a search server coupled to the physical devices, the search server managing distribution of search criteria from the client user interface to the search agents and managing return of result metadata to the client user interface.

The system may further comprise one or more virtual applications providing content storage; search agents associated with the one or more virtual applications; and the search server managing distribution of the search criteria to the one or more virtual applications' search agents and managing return of result metadata to the client user interface.

The metadata in the system may comprise one or more of a name of a device where content is located, an original file path, a file type, a file creation date, a file size, and relevant information regarding the content other than the content itself.

The at least one client user interface in the system may be configured to receive a content selection from the user, send the content selection to the search server; and receive selected content from the search server.

The search server in the system may be configured to receive a content selection from the at least one client user interface, send the content selection to the search agent on a remote device associated with the content selection; and receive selected content from the remote device.

The remote device in the system may be configured to receive the search criteria, search content by a local search agent using the search criteria; and send the result metadata from the local search agent to the search server.

The at least one client user interface in the system may be configured to combining the result metadata for presentation to the user.

An example computer-implemented method comprises: receiving search criteria at a user interface client on a user device; sending the search criteria to search agents on one or more remote devices using peer-to-peer communication; receiving result metadata at the user interface client from the one or more remote devices using peer-to-peer communication; and combining the result metadata for presentation to the user.

The computer-implemented method may further comprise: receiving a content selection from the user; sending the content selection to a remote device associated with the content selection the search server; and receiving selected content from the remote device using peer-to-peer communication.

The computer-implemented method may further comprise: searching content in storage regions designated on a white list or not designated on a black list on the remote devices.

The metadata in the computer-implemented method may comprise one or more of a name of a device where content is located, an original file path, a file type, a file creation date, a file size, and relevant information regarding the content other than the content itself.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving search criteria at a user interface client on a user device;
sending the search criteria to a search server;
receiving result metadata at the user interface client from the search server; and
combining the result metadata for presentation to the user.

2. The computer-implemented method of claim 1, further comprising:
forwarding the search criteria from the search server to search agents on one or more remote devices;
receiving the result metadata from the search agent on each remote device at the search server; and
forwarding the result metadata to the user interface client.

3. The computer-implemented method of claim 2, further comprising:
searching content on the remote devices by the search agents using the search criteria; and
sending the result metadata from the search agent on each remote device to the search server.

4. The computer-implemented method of claim 1, further comprising:
receiving a content selection from the user;
sending the content selection to the search server;
forwarding the content selection to the search agent on a remote device associated with the content selection;
sending selected content from the search agent on the remote device to the search server; and
forwarding the selected content to the user interface client on the user device.

5. The computer-implemented method of claim 1, further comprising:
providing the search criteria to a local search agent on the user device;
searching content on the user device by the local search agent using the search criteria;
sending result metadata from the local search agent to the user interface client; and
combining the result metadata from the local search agent and from the remote devices for presentation to the user.

6. The computer-implemented method of claim 2, further comprising:
sending the search criteria from the search server to search agents on one or more remote devices in response to poll requests from the search agents.

7. The computer-implemented method of claim 3, further comprising:
searching content in storage regions designated on a white list on the remote devices.

8. The computer-implemented method of claim 3, further comprising:
searching content in storage regions not designated on a black list on the remote devices.

9. The computer-implemented method of claim 1, wherein the metadata comprises one or more of a name of a device where content is located, an original file path, a file type, a file creation date, a file size, and relevant information regarding the content other than the content itself.

10. A system comprising:
two or more physical devices each having content storage;
search agents on each of the physical devices;
at least one client user interface allowing a user to initiate a content search across each of the physical devices; and
a search server coupled to the physical devices, the search server managing distribution of search criteria from the client user interface to the search agents and managing return of result metadata to the client user interface.

11. The system of claim 10, further comprising:
one or more virtual applications providing content storage;
search agents associated with the one or more virtual applications; and
the search server managing distribution of the search criteria to the one or more virtual applications' search agents and managing return of result metadata to the client user interface.

12. The system of claim 10, wherein the metadata comprises one or more of a name of a device where content is located, an original file path, a file type, a file creation date, a file size, and relevant information regarding the content other than the content itself

13. The system of claim 10, wherein the at least one client user interface is configured to receive a content selection from the user, send the content selection to the search server; and receive selected content from the search server.

14. The system of claim 10, wherein the search server is configured to receive a content selection from the at least one client user interface, send the content selection to the search agent on a remote device associated with the content selection; and receive selected content from the remote device.

15. The system of claim 10, wherein the remote device is configured to receive the search criteria, search content by a local search agent using the search criteria; and send the result metadata from the local search agent to the search server.

16. The system of claim 10, wherein the at least one client user interface is configured to combining the result metadata for presentation to the user.

17. A computer-implemented method, comprising:
receiving search criteria at a user interface client on a user device;
sending the search criteria to search agents on one or more remote devices using peer-to-peer communication;
receiving result metadata at the user interface client from the one or more remote devices using peer-to-peer communication; and
combining the result metadata for presentation to the user.

18. The computer-implemented method of claim 17, further comprising:
receiving a content selection from the user;
sending the content selection to a remote device associated with the content selection the search server; and
receiving selected content from the remote device using peer-to-peer communication.

19. The computer-implemented method of claim 17, further comprising:
searching content in storage regions designated on a white list or not designated on a black list on the remote devices.

20. The computer-implemented method of claim 17, wherein the metadata comprises one or more of a name of a device where content is located, an original file path, a file type, a file creation date, a file size, and relevant information regarding the content other than the content itself.
